(19) United States
(12) Patent Application Publication
(10) Pub. No.: US 2026/0218848 A1
(43) Pub. Date: Jul. 30, 2026

(54) DECK HANGER SYSTEM

(71) Applicant: Duro Dyne National Corp., Bay Shore, NY (US)

(72) Inventors: Andrew J. Bellise, Farmingdale, NY (US); Bill Whobrey, Louisville, KY (US); Eric Johannesen, Seaford, NY (US); Clara Accomando, Oceanside, NY (US); Ainsley Smith, Laurelton, NY (US)

(21) Appl. No.: 19/460,996

(22) Filed: Jan. 27, 2026

Related U.S. Application Data
(60) Provisional application No. 63/751,467, filed on Jan. 30, 2025.

(51) Int. Cl. F16M 13/02

(52) U.S. Cl. CPC F16M 13/02

(57) ABSTRACT

A deck hanger system includes a mounting device comprising an upper surface, a lower surface, a central surface, and a protruding finger defining a cavity disposed centrally along a diameter of the central surface; a top cap encasing the protruding finger; and a swage configured to be disposed within the cavity of the protruding finger such that the swage extends perpendicular to a bottom portion of a deck surface, wherein the swage includes a hollow internal cavity for passing wiring therethrough.

### CROSS REFERENCE TO RELATED APPLICATIONS

This application claims the benefit of U.S. Provisional Application number 63/751,467 filed January 30, 2025, and entitled “Deck Hanger System”, which is hereby incorporated by reference in its entirety.

### TECHNICAL FIELD

The subject matter of the present disclosure relates generally to a deck hanger system and, in particular, a deck hanger system designed for easy access and alteration, allowing for adjustments to be made even after the system has been securely cemented in place.

### BACKGROUND

Traditional deck hanger mounting devices lack accessibility for future adjustments, particularly in situations where wiring, plumbing, or other utilities are installed behind or alongside the mounting devices. Once the mounting devices are cemented in place, it becomes nearly impossible to make adjustments or repairs without the need for significant demolition. This can pose a major problem if wiring needs to be altered or upgraded, as it often requires tearing apart sections of the deck to access those areas, leading to costly and time-consuming repairs. The inability to easily adjust wiring or utilities once the mounting device is cemented creates long-term challenges in maintaining and upgrading a deck given that over time, changes to electrical, plumbing, or communication systems might be necessary due to new technology, code updates, or simple wear and tear. With traditional mounting devices, once the structure is in place, access to these systems is limited, forcing homeowners or contractors to dismantle parts of the deck to reach the wiring or plumbing. This not only results in significant labor costs but also increases the risk of damaging the deck’s structural integrity during the removal process. Furthermore, the inability to alter the structure may hinder future renovations or repairs, making it difficult to adapt the deck to changing needs or compliance requirements, ultimately compromising the deck’s longevity.

Accordingly, there is a need for a deck hanger system designed for easy access and alteration, allowing for adjustments to be made even after the system has been securely cemented in place.

### SUMMARY

An aspect of the present disclosure provides a deck hanger system. The deck hanger system includes a mounting device, the mounting device comprising an upper surface configured to protrude perpendicular to a top portion of a deck surface; a lower surface configured to be disposed along the top portion of the deck surface; and a central surface disposed along a top surface area of the lower surface, the central surface being configured to be secured to the top portion of the deck surface. The central surface includes a protruding finger defining a cavity disposed centrally along a diameter of the central surface. The deck hanger system further includes a top cap encasing the protruding finger; and a swage configured to be disposed within the cavity of the protruding finger such that the swage extends perpendicular to a bottom portion of the deck surface. The swage includes a hollow internal cavity for passing wiring therethrough.

In an aspect of the present disclosure, the upper surface may extend outwardly parallel to a first edge of the central surface.

In another aspect of the present disclosure, the upper surface may be configured to be connected to the central surface via a top surface of a connector surface that extends perpendicular to the first edge of the central surface.

In yet another aspect of the present disclosure, the central surface may be secured to the top portion of the deck surface by a fastener including at least one of a screw, a bolt, or a nail.

In an aspect of the present disclosure, the cavity of the protruding finger may include a first aperture defined centrally therein through which the swage is disposed and a second aperture disposed below the first aperture configured to lie in a direction opposing a direction of the first aperture.

In another aspect of the present disclosure, the swage may include a head portion identical in shape to the first aperture and the second aperture.

In yet another aspect of the present disclosure, the swage may be inserted into the first aperture through an underside surface of the protruding finger.

In another aspect of the present disclosure, when the head portion of the swage is aligned with a direction of the first aperture, the swage may be removable.

In yet another aspect of the present disclosure, when the head portion of the swage is rotated to align with the direction of the second aperture, the swage may be locked in place on the central surface.

In an aspect of the present disclosure, the top cap may be removable.

In another aspect of the present disclosure, the top cap may be secured onto the central surface via fasteners including screws, bolts, and/or nails.

In another aspect of the present disclosure, the system may further include a removable end cap configured to connect to an end portion of the swage. The removable end cap may be configured to cover an end portion of the swage.

An aspect of the present disclosure provides a deck hanger system. The deck hanger system includes a mounting device, the mounting device comprising an upper surface configured to protrude perpendicular to a top portion of a deck surface; a lower surface configured to be disposed along the top portion of the deck surface; and a central surface disposed along a top surface area of the lower surface, the central surface being configured to be secured to the top portion of the deck surface. The central surface includes a protruding finger defining a cavity disposed centrally along a diameter of the central surface. The deck hanger system further includes a top cap encasing the protruding finger.

In an aspect of the present disclosure, the system may further include a swage configured to be disposed within the cavity of the protruding finger such that the swage extends perpendicular to a bottom portion of the deck surface.

In another aspect of the present disclosure, the swage may include a hollow internal cavity for passing wiring therethrough.

In yet another aspect of the present disclosure, the cavity of the protruding finger may include a first aperture defined centrally therein through which the swage is disposed and a second aperture disposed below the first aperture configured to lie in a direction opposing a direction of the first aperture.

In an aspect of the present disclosure, the swage may include a head portion identical in shape to the first aperture and the second aperture.

In another aspect of the present disclosure, the swage may be inserted into the first aperture through an underside surface of the protruding finger.

In yet another aspect of the present disclosure, when the head portion of the swage is aligned with a direction of the first aperture, the swage may be removable.

In an aspect of the present disclosure, when the head portion of the swage is rotated to align with the direction of the second aperture, the swage may be locked in place on the central surface.

### BRIEF DESCRIPTION OF THE DRAWINGS

A better understanding of the features and advantages of the present disclosure will be obtained by reference to the following detailed description that sets forth illustrative embodiments, in which the principles of the present disclosure are utilized, and the accompanying drawings of which:

FIG. 1 is a diagram of a deck hanger system, in accordance with aspects of the present disclosure;

FIG. 2 is a top perspective view of a mounting device of the deck hanger system of FIG. 1, in accordance with aspects of the present disclosure;

FIG. 3 is a diagram of the mounting device of FIG. 2, in accordance with aspects of the present disclosure;

FIG. 4A is a cross-sectional view of a protruding finger of the deck hanger system of FIG. 1, in accordance with aspects of the present disclosure;

FIG. 4B is a top perspective view of the deck hanger system of FIG. 1, in accordance with aspects of the present disclosure;

FIG. 5 is a cross-sectional view of a plurality of threads of the protruding finger of FIG. 4A, in accordance with aspects of the present disclosure;

FIG. 6 is a top perspective view of a cavity of the protruding finger of FIG. 4A, in accordance with aspects of the present disclosure;

FIG. 7 is a diagram of the mounting device of FIG. 2, in accordance with aspects of the present disclosure;

FIG. 8 is a top perspective view of the mounting device of FIG. 2, in accordance with aspects of the present disclosure;

FIG. 9 is a side perspective view of the mounting device of FIG. 2, in accordance with aspects of the present disclosure;

FIG. 10 is a perspective view of the mounting device of FIG. 2, in accordance with aspects of the present disclosure;

FIG. 11 is a bottom perspective view of a top cap of the deck hanger system of FIG. 1, in accordance with aspects of the present disclosure;

FIG. 12 is a perspective view of the top cap of FIG. 11, in accordance with aspects of the present disclosure;

FIG. 13 is a side perspective view of the top cap of FIG. 11, in accordance with aspects of the present disclosure;

FIG. 14 is a front perspective view of the top cap of FIG. 11, in accordance with aspects of the present disclosure;

FIG. 15 is a cross-sectional side perspective view of the top cap of FIG. 11, in accordance with aspects of the present disclosure;

FIG. 16 is a diagram of a swage of the deck hanger system of FIG. 1, in accordance with aspects of the present disclosure;

FIG. 17 is a diagram of the swage of FIG. 16, in accordance with aspects of the present disclosure;

FIG. 18 is a cross-sectional view of the swage of FIG. 16, in accordance with aspects of the present disclosure;

FIG. 19 is an enlarged view of the swage of FIG. 16, in accordance with aspects of the present disclosure;

FIG. 20 is a top perspective view of the swage of FIG. 16, in accordance with aspects of the present disclosure;

FIG. 21 is a top perspective view of an end cap of the deck hanger system of FIG. 1, in accordance with aspects of the present disclosure;

FIG. 22 is a side perspective view of the end cap of FIG. 21, in accordance with aspects of the present disclosure;

FIG. 23 is a cross-sectional view of the end cap of FIG. 21, in accordance with aspects of the present disclosure; and

FIG. 24 is a diagram of the end cap of FIG. 21, in accordance with aspects of the present disclosure.

### DETAILED DESCRIPTION

The present disclosure relates generally to a deck hanger system. In particular, the present disclosure relates generally to a deck hanger system designed for easy access and alteration, allowing for adjustments to be made even after the system has been securely cemented in place.

Although the present disclosure will be described in terms of specific examples, it will be readily apparent to those skilled in this art that various modifications, rearrangements, and substitutions may be made without departing from the spirit of the present disclosure.

For the purpose of promoting an understanding of the principles of the present disclosure, reference will now be made to exemplary embodiments illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

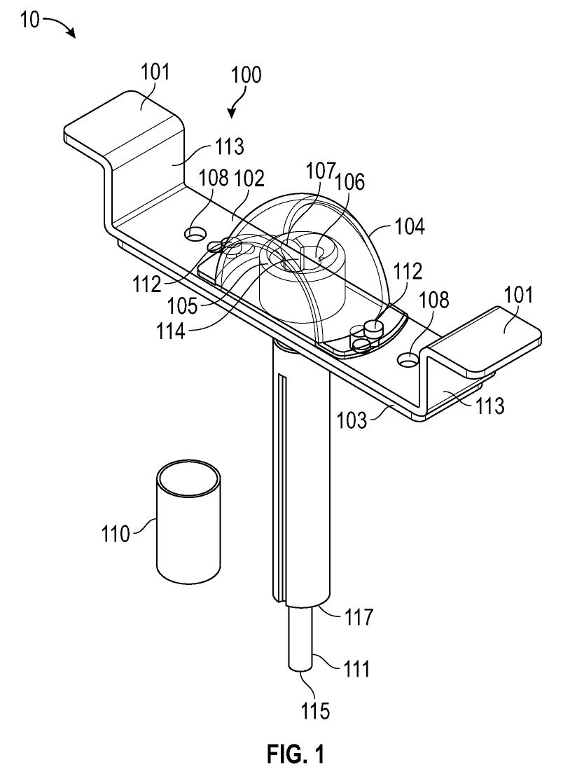

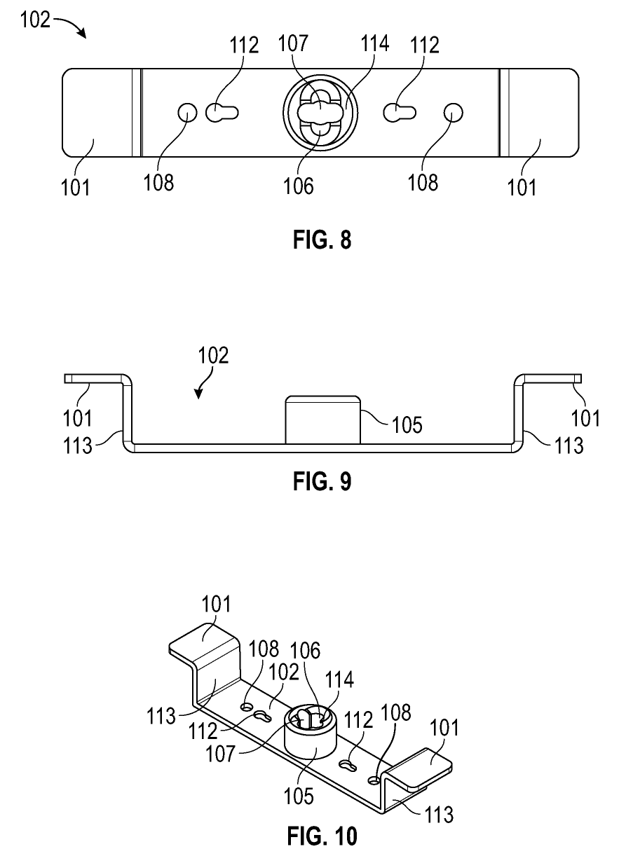

Referring to FIGS. 1-24, a deck hanger system 10 is shown in accordance with aspects of the present disclosure. Deck hanger system 10 (FIG. 1) includes a mounting device 100 (FIGS. 8-10) that is configured to be secured to a deck surface. In various embodiments, mounting device 100 is composed of acrylonitrile butadiene styrene (ABS). Using ABS provides the added benefit of enhanced durability, impact resistance, and weatherproofing, making it ideal for outdoor environments. Further, the lightweight nature and malleability of ABS also allow for unique and complex designs while maintaining cost-effectiveness and long-term performance. In other embodiments, mounting device 100 may be composed of steel, aluminum, composite material(s), brass, or bronze. Mounting device 100 may be of varying dimensions (e.g., length, width, thickness) to accommodate various deck surfaces and ensure optimal security upon installation.

Mounting device 100 includes an upper surface 101, a lower surface 103, and a central surface 102. Upper surface 101 is configured to protrude perpendicular to a top portion of the deck surface. Upper surface 101 is designed to accommodate a wide range of angles (e.g., 90°, 95°, 98°) and orientations, allowing it to adapt seamlessly to various deck surfaces. This flexibility ensures compatibility with uneven, sloped, or uniquely shaped decking layouts. Upper surface 101 is configured to extend outwardly parallel to a first edge of the central surface 102. In some embodiments, upper surface 101 may extend perpendicular to central surface 102. Upper surface 101 is connected to central surface 102 via a connector surface 113 that extends perpendicular to the first edge of central surface 102. More specifically, upper surface 101 is connected to a top surface of connector surface 113. Upper surface 101 may be connected to connector surface 113 by a variety of methods including, but not limited to, solvent welding, heat welding, ultrasonic welding, and through the use of adhesive materials (e.g., cyanoacrylate, solvent cement, epoxy adhesives, acrylic adhesives, and/or polyurethane adhesives). The choice of method is dependent upon required bond strength and environmental conditions. Upper surface 101 serves the benefit of providing a secure attachment point for connecting structural elements, such as beams, posts, or decking boards. Upper surface 101 helps distribute loads evenly, ensures stability, and supports the alignment of the decking components.

Lower surface 103 is configured to be disposed and secured along the top portion of the deck surface. Lower surface 103 sits flush against the deck surface, providing a stable foundation for secure attachment. Lower surface 103 serves the benefits of creating a solid foundation that helps distribute loads evenly, preventing concentrated pressure points that could damage the deck, maximizing contact with the deck surface, ensuring a strong and reliable connection, and transferring the weight and forces from the connected structural elements, such as posts or beams, directly to the deck surface, enhancing overall structural integrity. Further, lower surface 103 aids in minimizing vibrations or shifting under dynamic loads, lending hand to improved durability. In various embodiments, lower surface 103 may be adjusted to adapt to various deck surfaces by shaping or molding it into a curved or angled profile to match sloped or contoured deck surfaces. Adjustable features, such as threaded feet or leveling mechanisms, can be integrated to allow for adaptation to uneven surfaces. Additionally, incorporating flexible materials like rubber or silicone pads on an underside of lower surface 103 can help absorb irregularities while also providing grip and reducing damage to the deck surface. Lower surface 103 may be of varying dimensions (e.g., length, width, thickness) to accommodate various deck surfaces and ensure optimal security upon installation.

Central surface 102 is disposed along a top surface area of lower surface 103 and is configured to be secured to the top portion of the deck surface, securing lower surface 103 in place along with it. Central surface 102 may be secured onto the top portion of the deck surface by inserting a fastener through fastener holes 108. A wide variety of fasteners may be utilized including, but not limited to, screws, bolts, nails, wood screws, lag bolts, deck screws, machines screws with nuts, concrete anchors, self-tapping screws, threaded inserts, and/or rivets. The choice of fastener depends upon the deck surface and the load requirements. Central surface 102 provides the added benefit of an additional structural layer that supports and stabilizes the overall design of mounting device 100. Central surface 102 serves the purpose of ensuring efficient and even transfer of weights and forces from components attached to mounting device 100 (e.g., beams, posts) to lower surface 103 and the deck surface. Further, central surface 102 adds rigidity and durability to mounting device 100, ensures proper alignment between lower surface 103 and attached components, and helps anchor mounting device 100 firmly to the deck surface, mitigating the negative effects of movement and vibrations. Central surface 102 may be enhanced to adapt to various deck surfaces by incorporating adjustable pads or feet to accommodate uneven or sloped deck surfaces. Further, the utilization of materials like rubber or silicone to conform to irregularities in the deck surface can help absorb vibrations and mitigate the risk of damage to both mounting device 100 and the deck surface. In some embodiments central surface 102 may be shaped to have a concave or convex form to better align with the deck surface and ensure a more stable connection. Central surface 102 may be of varying dimensions (e.g., length, width, thickness) to accommodate various deck surfaces and ensure optimal security upon installation.

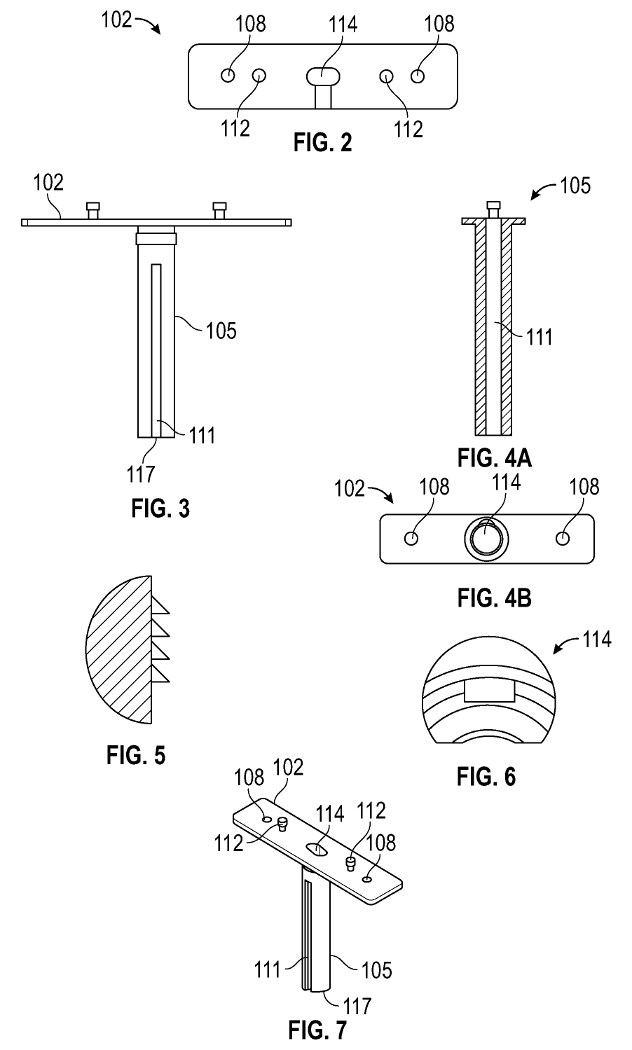

Central surface 102 includes a protruding finger 105 defining a cavity 114 disposed centrally along a diameter of the central surface 102 (FIGS. 2-7). Protruding finger 105 may be of varying dimensions (e.g., length, width, thickness). In various embodiments, protruding finger 105 (FIG. 3) may be disposed anywhere along the diameter of central surface 102. Protruding finger 105 is configured to protrude upward perpendicular to a top surface area of central surface 102 and downwards through central surface 102, and inherently lower surface 103, thereby protruding downwards perpendicular to a bottom surface area of lower surface 103 such that it hangs below the deck surface. Protruding finger 105 provides the added benefit of enhanced stability, improved load distribution, simplified installation, and resistance against corrosion.

Protruding finger 105 includes a first aperture 107 (FIG. 8) defined centrally therein through which a swage 111 is disposed such that swage 111 extends perpendicular to a bottom portion of the deck surface. Protruding finger 105 further includes a second aperture 106 disposed below first aperture 107 (FIG. 8), the second aperture 106 being configured to lie in a direction opposing a direction of first aperture 107. First aperture 107 and second aperture 106 can be of varying shapes and dimensions to accommodate different swages 111. For example, first aperture 107 and second aperture 106 may be rounded to accommodate a cylindrical swage 111, square to accommodate a swage 111 with square cross-sections, rectangular, hexagonal, or triangular, among other configurations. By incorporating these varied shapes, deck hanger system 10 can effectively interface with a wide range of swage 111 types, enhancing the versatility and adaptability of the deck hanger system 10. This ensures that each connection is optimized for strength, stability, and longevity. In various embodiments, cavity 114 and swage 111 may be threaded such that swage 111 is threadedly coupled to cavity 114 for enhanced stability and security.

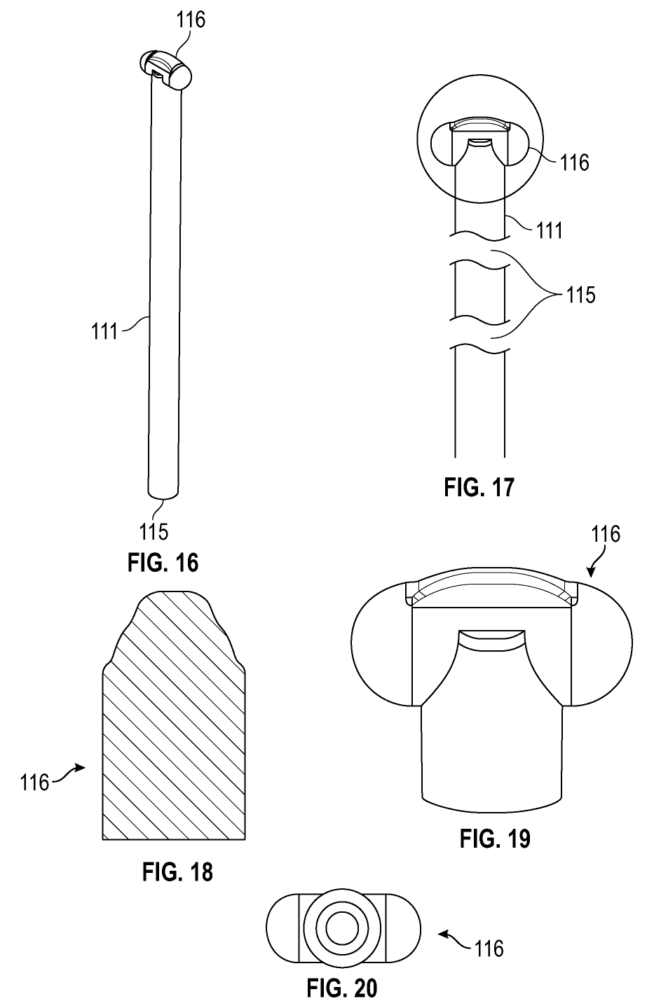

Swage 111 includes a head portion 116 (FIGS. 16-20) identical in shape (e.g., oval, round, rectangular, square) to first aperture 107 and second aperture 106. Swage 111 is inserted into first aperture 107 through an underside surface 117 of protruding finger 105. When head portion 116 is aligned with a direction of first aperture 107, swage 111 is removable. On the contrary, when head portion 116 is rotated to align with a direction of second aperture 106, swage 111 is locked in place on central surface 102. Swage 111, and in particular the locking of swage 111 into second aperture 106 such that is secured on central surface 102, provides the benefit of a fixed and stable point, preventing slippage and maintaining the desired tension in wiring that may be passed through a hollow internal cavity 115 of swage 111. In various embodiments, a variety of items including, but not limited to, aviation-grade galvanized wire rope, stainless steel cables, electrical wiring, chain link, vinyl-coated wire rope, and fiber optic cables may be passed through hollow internal cavity 115 of swage 111. In order to accommodate a wide variety of items, hollow internal cavity 115 may be of varying dimensions (e.g., widths).

In various embodiments, swage 111 may be composed of solid material including cold-rolled steel, aluminum, galvanized steel, copper, brass, composite materials, and/or plastic, among other materials. The choice of material depends on factors like load requirements, exposure to elements, cost, and desired aesthetics. For example, stainless steel is ideal for high-tension outdoor systems, while aluminum’s lightweight properties make it ideal for less demanding environments. Cold-rolled steel offers enhanced strength, improved dimensional accuracy, high resistance to deformation, and a high-quality surface finish. In some embodiments, the cold-rolled steel swage 111 may be coated or treated (e.g., galvanized) to improve its resistance to rust and corrosion.

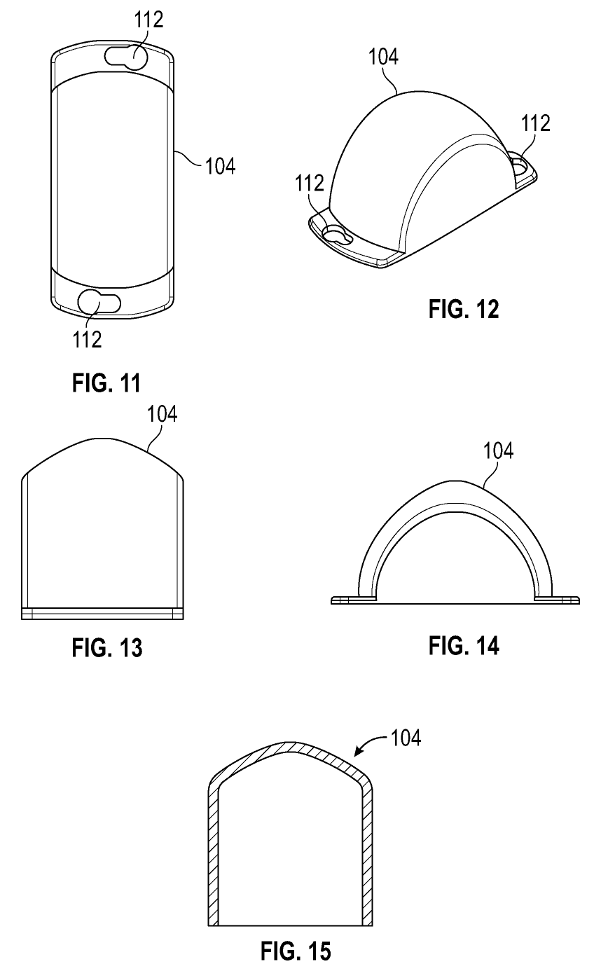

Deck hanger system 10 further includes a top cap 104 (FIGS. 11-15) encasing protruding finger 105. Top cap 104 may be secured onto central surface 102 by inserting a fastener through fastener holes 112. A wide variety of fasteners may be utilized including, but not limited to, screws, bolts, nails, wood screws, lag bolts, deck screws, machines screws with nuts, concrete anchors, self-tapping screws, threaded inserts, clips, and/or rivets. In other embodiments, top cap 104 may be secured onto central surface 102 through the use of a wide variety of adhesives (e.g., epoxy resin, polyurethane adhesive, silicone adhesive, cyanoacrylate, acrylic adhesive). Top cap 104 may be designed with varying shapes (e.g., curved, square, rectangular) and dimensions (e.g., width, height, length) to accommodate protruding fingers 105 of varying dimensions, ensuring a secure and stable fit. These variations in shape allow top cap 104 to effectively house and encase protruding finger 105, providing a protected environment that prevents shifting, movement, and/or contamination. Further, top cap 104 prevents any external forces from dislodging or damaging protruding finger 105, thus enhancing the overall strength and stability of deck hanger system 10. The use of top cap 104 to protect protruding finger 105 on deck hanger system 10 offers significant benefits, particularly in terms of long-term access and adjustability. By encasing protruding finger 105 and internally disposed swage 111 inside top cap 104, these critical components are shielded from environmental elements and physical damage, maintaining the integrity of the connection. One of the substantial benefits is that top cap 104 allows for continued access to protruding finger 105 and swage 111 even after the deck surface has been cemented or finished as, in some embodiments, top cap 104 may be removable. This accessibility is crucial for making future adjustments, such as tightening or loosening cables, or replacing worn components. Without top cap 104, once the deck hanger system 10 is fully installed, accessing swage 111 or protruding finger 105 could be difficult or even impossible, particularly in systems that are securely integrated into a deck structure. Top cap 104 ensures that maintenance, adjustments, and repairs can be carried out as needed, extending the lifespan of deck hanger system 10 and maintaining its functionality over time. Top cap 104 may be composed of acrylonitrile butadiene styrene (ABS), steel, aluminum, composite material(s), brass, or bronze.

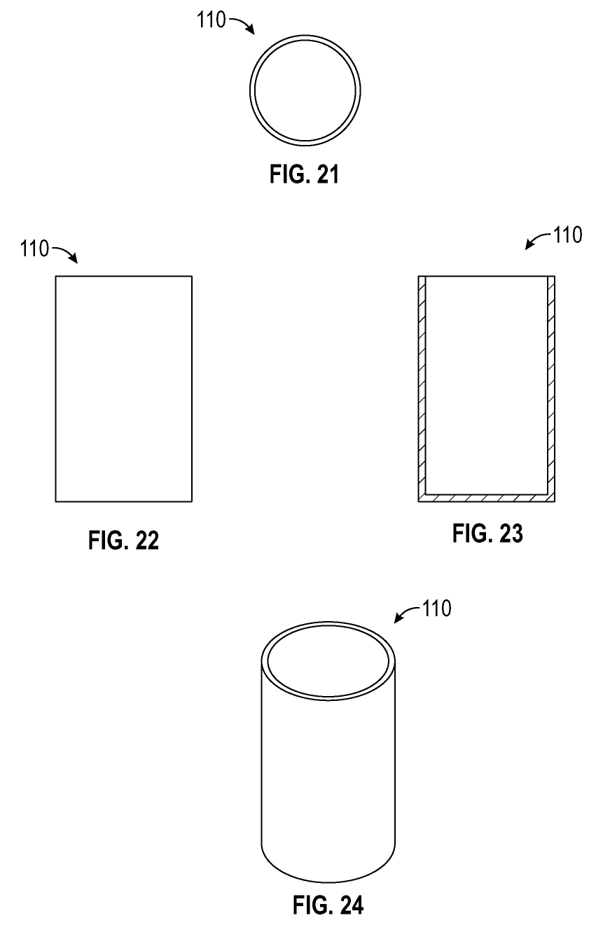

Deck hanger system 10 further includes a removable end cap 110 (FIGS. 21-24) configured to connect to an end portion of swage 111. Removable end cap 110 is configured to cover an end portion of swage 111 such that swage 111 is safeguarded from environmental elements, contaminants (e.g., applying insulation spray from under decking prior to hanging cables from deck hanger system 10), and physical damage. End cap 110 may be composed of acrylonitrile butadiene styrene (ABS), steel, aluminum, composite material(s), brass, or bronze. End cap 110 may be of varying dimensions (e.g., length, width, thickness) to accommodate various swage 111 and protruding finger 105 dimensions and ensure that swage 111 is properly encased.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures. While several examples have been provided in the present disclosure, it should be understood that the disclosed examples might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

The phrases “in an embodiment,” “in embodiments,” “in various embodiments,” “in some embodiments,” or “in other embodiments” may each refer to one or more of the same or different example embodiments provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. 112(f) as it exists on the date of filing hereof unless the words “means for” or “step for” are explicitly used in the particular claim. Further, the closed form phrase "consisting of" may be used in the place of open form term "comprising" to indicate a disclosed system, apparatus, device, or method having only the recited elements

What is claimed is:

1. A deck hanger system, comprising:
a mounting device, the mounting device comprising:
an upper surface configured to protrude perpendicular to a top portion of a deck surface;
a lower surface configured to be disposed along the top portion of the deck surface; and
a central surface disposed along a top surface area of the lower surface, the central surface being configured to be secured to the top portion of the deck surface,
wherein the central surface includes a protruding finger defining a cavity disposed centrally along a diameter of the central surface;
a top cap encasing the protruding finger; and
a swage configured to be disposed within the cavity of the protruding finger such that the swage extends perpendicular to a bottom portion of the deck surface,
wherein the swage includes a hollow internal cavity for passing wiring therethrough.

2. The system of claim 1, wherein the upper surface extends outwardly parallel to a first edge of the central surface.

3. The system of claim 2, wherein the upper surface is configured to be connected to the central surface via a top surface of a connector surface that extends perpendicular to the first edge of the central surface.

4. The system of claim 1, wherein the central surface is secured to the top portion of the deck surface by a fastener including at least one of a screw, a bolt, or a nail.

5. The system of claim 1, wherein the cavity of the protruding finger includes a first aperture defined centrally therein through which the swage is disposed and a second aperture disposed below the first aperture configured to lie in a direction opposing a direction of the first aperture.

6. The system of claim 5, wherein the swage is inserted into the first aperture through an underside surface of the protruding finger.

7. The system of claim 5, wherein the swage includes a head portion identical in shape to the first aperture and the second aperture.

8. The system of claim 7, wherein when the head portion of the swage is aligned with a direction of the first aperture, the swage is removable.

9. The system of claim 7, wherein when the head portion of the swage is rotated to align with a direction of the second aperture, the swage is locked in place on the central surface.

10. The system of claim 1, wherein the top cap is removable.

11. The system of claim 1, wherein the top cap is secured onto the central surface via fasteners including screws, bolts, and/or nails.

12. The system of claim 1, further comprising:
a removable end cap configured to connect to an end portion of the swage, wherein the removable end cap is configured to cover an end portion of the swage.

13. A deck hanger system, comprising:
a mounting device, the mounting device comprising:
an upper surface configured to protrude perpendicular to a top portion of a deck surface;
a lower surface configured to be disposed along the top portion of the deck surface; and
a central surface disposed along a top surface area of the lower surface, the central surface being configured to be secured to the top portion of the deck surface,
wherein the central surface includes a protruding finger defining a cavity disposed centrally along a diameter of the central surface; and
a top cap encasing the protruding finger.

14. The system of claim 13, further comprising:
a swage configured to be disposed within the cavity of the protruding finger such that the swage extends perpendicular to a bottom portion of the deck surface.

15. The system of claim 14, wherein the swage includes a hollow internal cavity for passing wiring therethrough.

16. The system of claim 14, wherein the cavity of the protruding finger includes a first aperture defined centrally therein through which the swage is disposed and a second aperture disposed below the first aperture configured to lie in a direction opposing a direction of the first aperture.

17. The system of claim 16, wherein the swage is inserted into the first aperture through an underside surface of the protruding finger.

18. The system of claim 16, wherein the swage includes a head portion identical in shape to the first aperture and the second aperture.

19. The system of claim 18, wherein when the head portion of the swage is aligned with a direction of the first aperture, the swage is removable.

20. The system of claim 18, wherein when the head portion of the swage is rotated to align with a direction of the second aperture, the swage is locked in place on the central surface.
